(19) United States
(12) Patent Application Publication
(10) Pub. No.: US 2018/0150525 A1
(43) Pub. Date: May 31, 2018

(54) Methods and Systems for Prioritizing Entities in Search Results

(71) Applicant: Facebook, Inc., Menlo Park, CA (US)

(72) Inventors: Robert Franklin Daniel, Redwood City, CA (US); Edward Young Zhang, San Francisco, CA (US); Matthew Robert Anger, San Francisco, CA (US); Weiwei Ding, Fremont, CA (US); Tsung-Chuan Chen, Palo Alto, CA (US); Qian Wang, Fremont, CA (US)

(21) Appl. No.: 15/364,183

(22) Filed: Nov. 29, 2016

(51) Int. Cl. G06F 17/30

(52) U.S. Cl. CPC G06F 17/30554; H04L 51/32; G06F 17/30477; G06F 17/3053

(57) ABSTRACT

Exemplary embodiments relate to techniques for providing search results, such as when performing a type-ahead search. If an exact match to the search query is available, the exact match is used. If no exact match exists, search results are prioritized based primarily on responsiveness and pixel data, and secondarily based on metrics including locale/location, fancount, and social signal information. If a user searches for an entity having multiple results, the system will attempt to find a local result that is proximate to the user, but will prioritize a search hit for a more responsive result over other results. This boosts the chance that the user will get a response if they leave a message for the searched entity. Entities may be omitted from search results if they are unable to send or receive messages.

### BACKGROUND

Social networking systems may include a number of entities with which a user can interact. Those entities may include individuals (such as other users), organizations (such as businesses, schools, teams, etc.), and messaging bots (which may be associated with another entity, such as an organization). When a user wishes to identify an entity with which to interact, the user may perform a search for the entity. In the past, interaction with these entities was often limited to passively viewing media the entity made available for consumption. However, recently it has become more common to engage with these entities through messaging services (e.g., directly communicating with a business or other organization). Thus, search algorithms that were optimized towards passive receipt of content may not return results that are well-suited to active communication between an entity and a user.

### BRIEF DESCRIPTION OF THE DRAWINGS

FIG. 1A depicts an exemplary interface for performing an entity search;

FIG. 1B depicts the interface of FIG. 1A after more of a search query is entered;

FIG. 1C depicts an exemplary interface for receiving media from subscribed entities in a messaging service;

FIG. 2 is a flowchart depicting exemplary logic for performing an entity search;

FIG. 3 is a flowchart depicting exemplary logic for delivering media from subscribed entities;

FIG. 4 is a data flow diagram depicting information exchange between various devices for performing an entity search and for delivering media from subscribed entities, according to an exemplary embodiment;

FIG. 5A is a block diagram providing an overview of a system including an exemplary centralized communications service;

FIG. 5B is a block diagram providing an overview of a system including an exemplary distributed communications service;

FIG. 5C depicts the social networking graph of FIGS. 5A-5B in more detail;

FIG. 6 is a block diagram depicting an example of a system for a messaging service;

FIG. 7 is a block diagram illustrating an exemplary computing device suitable for use with exemplary embodiments;

FIG. 8 depicts an exemplary communication architecture; and

FIG. 9 is a block diagram depicting an exemplary multicarrier communications device.

### DETAILED DESCRIPTION

Exemplary embodiments relate to techniques for providing search results, such as when performing a type-ahead search to identify entities in a messaging or social networking service. A search query may be entered in an interface to a messaging application or a social networking application associated with the messaging application. If an exact match to the search query is available (e.g., as a node in a social graph associated with the social networking service), the exact match is used. If no exact match exists, search results are prioritized based on responsiveness, as well as several factors such as pixel data associated with the user submitting the search query, locale/location, fancount, and social signal information. Entities may be omitted from search results if they are unable to send or receive messages (e.g., the entity has messaging turned off).

Because search results are prioritized based on responsiveness (e.g., how quickly and/or how frequently the entity responds to messages), the searching user is more likely to receive a response if they interact with the entity.

In some embodiments, users may be able to subscribe to an entity identified in the search results. When a subscribed-to entity generates content (such as an article, GIF, video, coupon, etc.), the content may be delivered as a message or message module to the subscribing user's account in a messaging system. This provides additional entry points in which users can identify or make contact with entities, and additional points of interaction with the entities (e.g., an entity identified through a social networking service may interact with users through an associated messaging service).

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

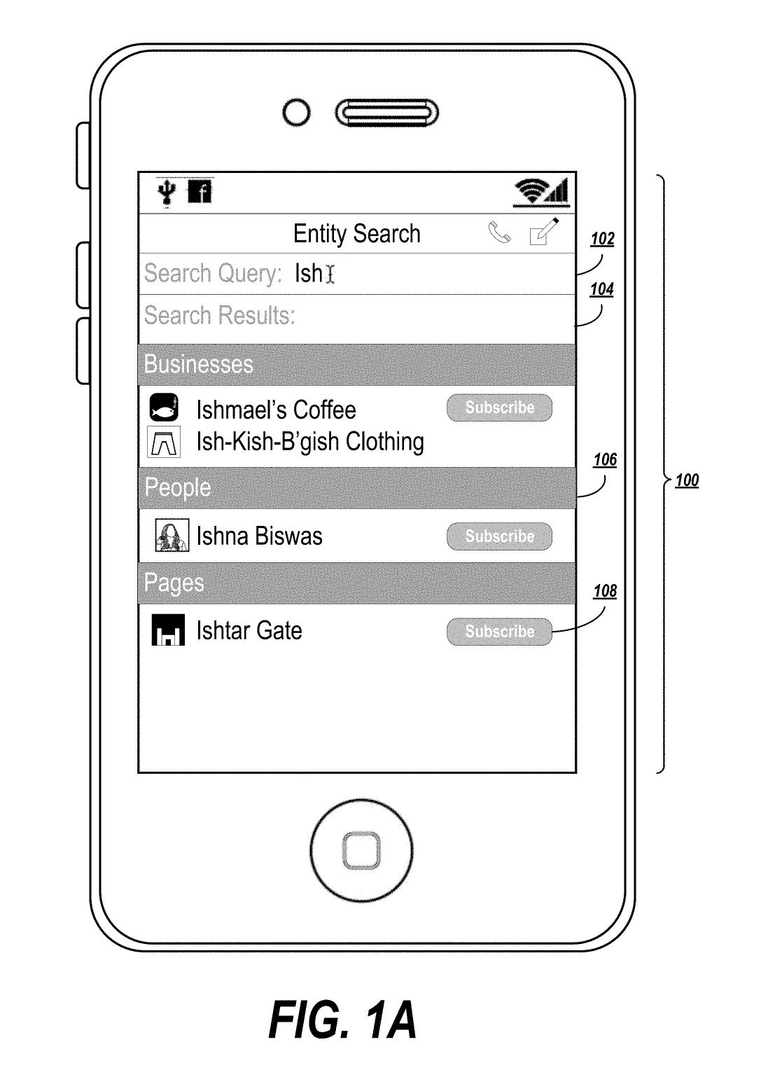

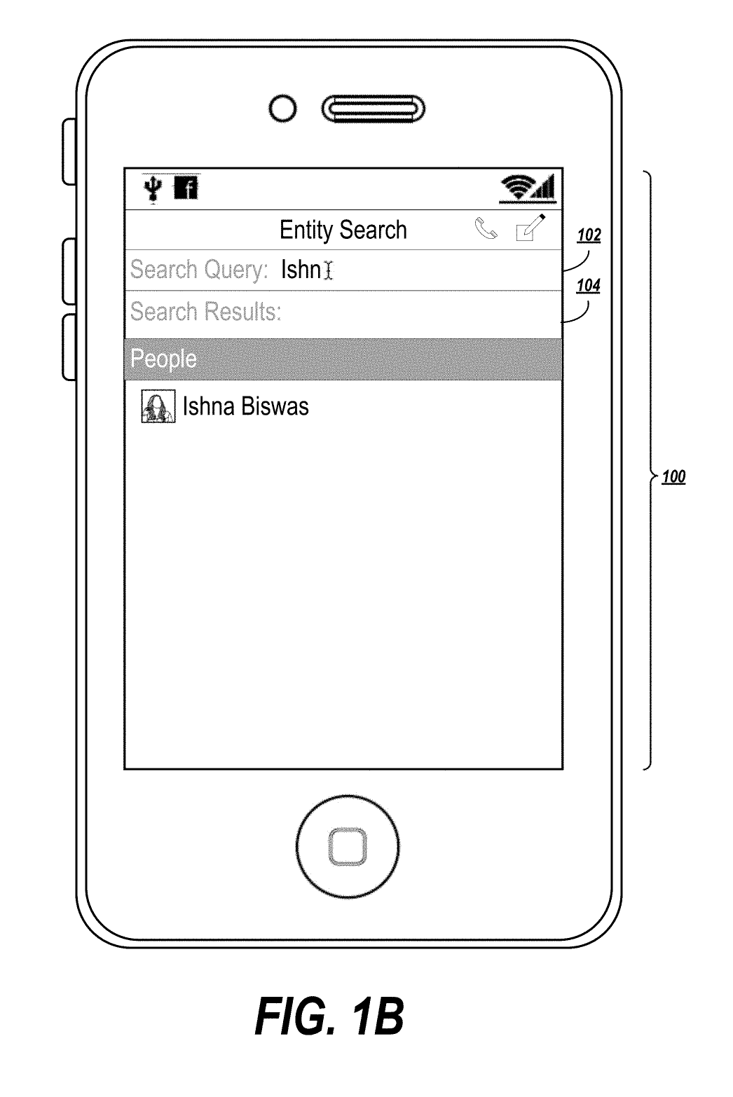

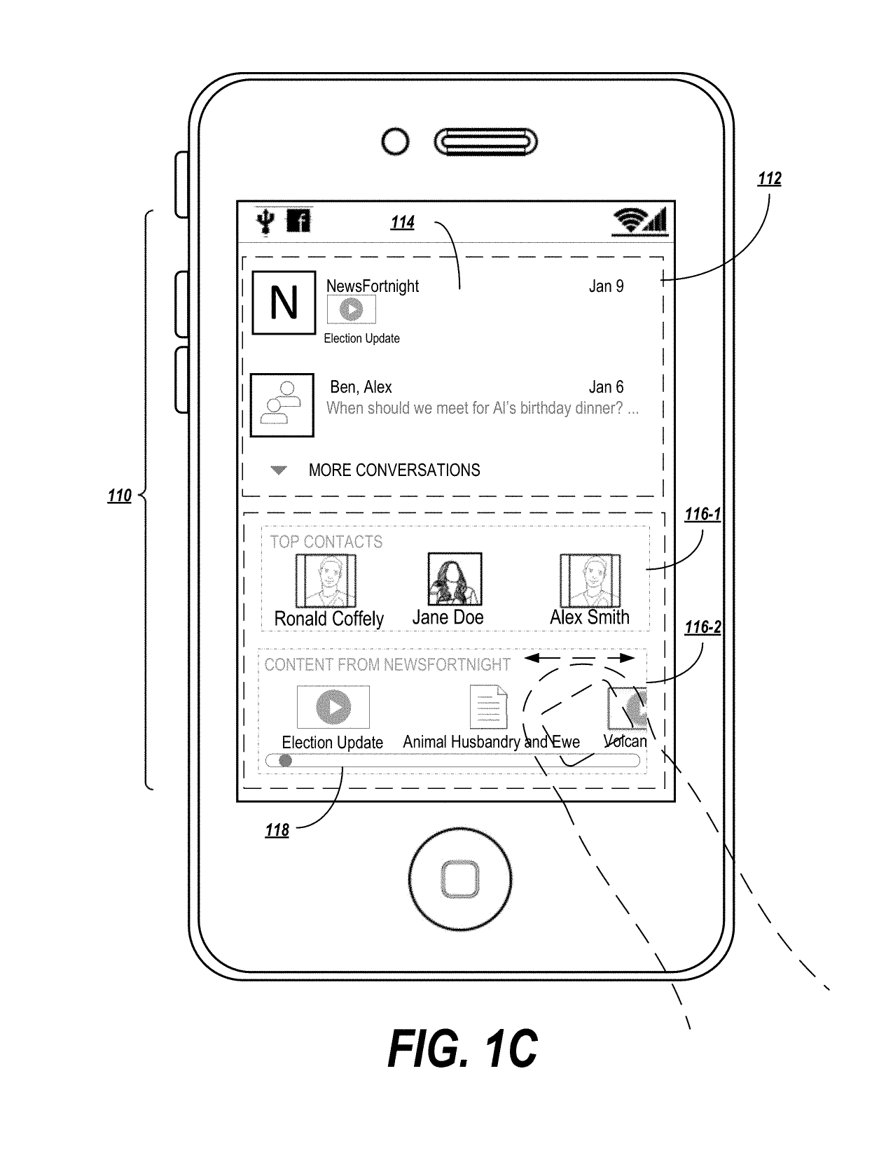

FIG. 1A depicts an exemplary interface 100 for searching for an entity. The interface 100 may be presented in a messaging application for a messaging service and/or a social networking application associated with the messaging service. For example, the interface 100 may be presented when a user searches for contacts to message through a messaging application, or pages to visit in a social networking application. Thus, exemplary embodiments provide entry points to a social networking service from a messaging service, and furthermore provide opportunities for social networking entities to engage with users via messages in the messaging service.

The interface 100 includes a search bar 102 for submitting a search query. According to some embodiments, the search query may be submitted one character at a time and each character (or subsets of characters) may be submitted to a server for performing a search (e.g., a look-ahead search) based on the partial query. Alternatively or in addition to entering text in the search bar 102, information may be submitted as a search query using other input methods (such as audio input).

Based on the search query submitted to the server, the server may search a social networking service (e.g., by searching a social graph of the social networking service) and one or more search results may be returned. The returned results may be displayed in a search results element 104.

The search results may displayed in a ranked order in the search results element 104. The ranked order may be determined based on a number of metrics; according to exemplary embodiments, one such metric is the responsiveness of the ranked entity. The responsiveness may represent, for example, the amount of time it generally takes before the entity responds to a message and/or the frequency at which the entity responds to messages.

The search results may include any type of entity represented in the social networking service, such as people, businesses, organizations, social networking pages, messaging bots, etc. (individually or in combination with each other). When more than one type of entity is present, the different types of entities may be graphically distinguished from each other. For example, the different types of entities may be represented in different sections of the search results element 104, divided by headers 106 identifying the types of the entities. Entities within a section may be ranked against each other, and each section may be ranked against other sections, as described in more detail below. Alternatively or in addition, the different types of entities may be presented together and ranked against each other without regard to the type of the entity.

As the user continues to enter additional information in the search bar 102, further search queries may be transmitted to the server and the search results element 104 may be updated. For example, FIG. 1B shows the interface 100 after further text has been entered. As shown in this example, the further text eliminated a number of possibilities which would not have been valid search results; these invalidated possibilities were removed from the search results element 104.

Returning to FIG. 1A, some or all of the entities may be subscribable. When a user subscribes to an entity, content produced by the entity may be delivered to a messaging account associated with the user. In order to subscribe to the entity, a subscription element 108 may be associated with the entity in the search results element 104. Upon selecting the subscription element 108, a server may associate the user's account with the entity such that future content from the entity is delivered to the user's account in the form of a message or messaging module.

For example, FIG. 1C depicts a messaging inbox interface 110. The messaging inbox interface 110 includes a first section 112 dedicated to presenting message threads. In this example, a first message thread 114 includes content provided by an entity to which the user associated with the messaging inbox has subscribed. The content may be presented in the form of a message.

In some embodiments, the messaging inbox interface 100 may be divided into two or more modules, as described in U.S. patent application Ser. No. 15/272,360, filed on Sep. 21, 2016 and entitled “Modular Inbox.” One module may provide message thread content, as described above, whereas the other modules may relate to other (non-message related) functionality of the messaging service. In this example, a module 116-1 provides a list of top contacts in the messaging service that the user may wish to message.

The content from the subscribed-to entity may be presented as a module 116-2 or may be integrated into another module (e.g., video content provided by the subscribee may be provided in a videos module, articles in an articles module, coupons in an advertising module, etc.).

In the event that the content fills more space than is available on a single screen (or the space otherwise allotted to the module 116-2), the module 116-2 may be scrollable in a horizontal or vertical direction. In the depicted example, the content may be scrolled horizontally by interacting with the module (e.g., by swiping horizontally on a touch-based display). The module 116-2 may include a scroll bar 118 that indicates a progress through the content available in the module 116-2.

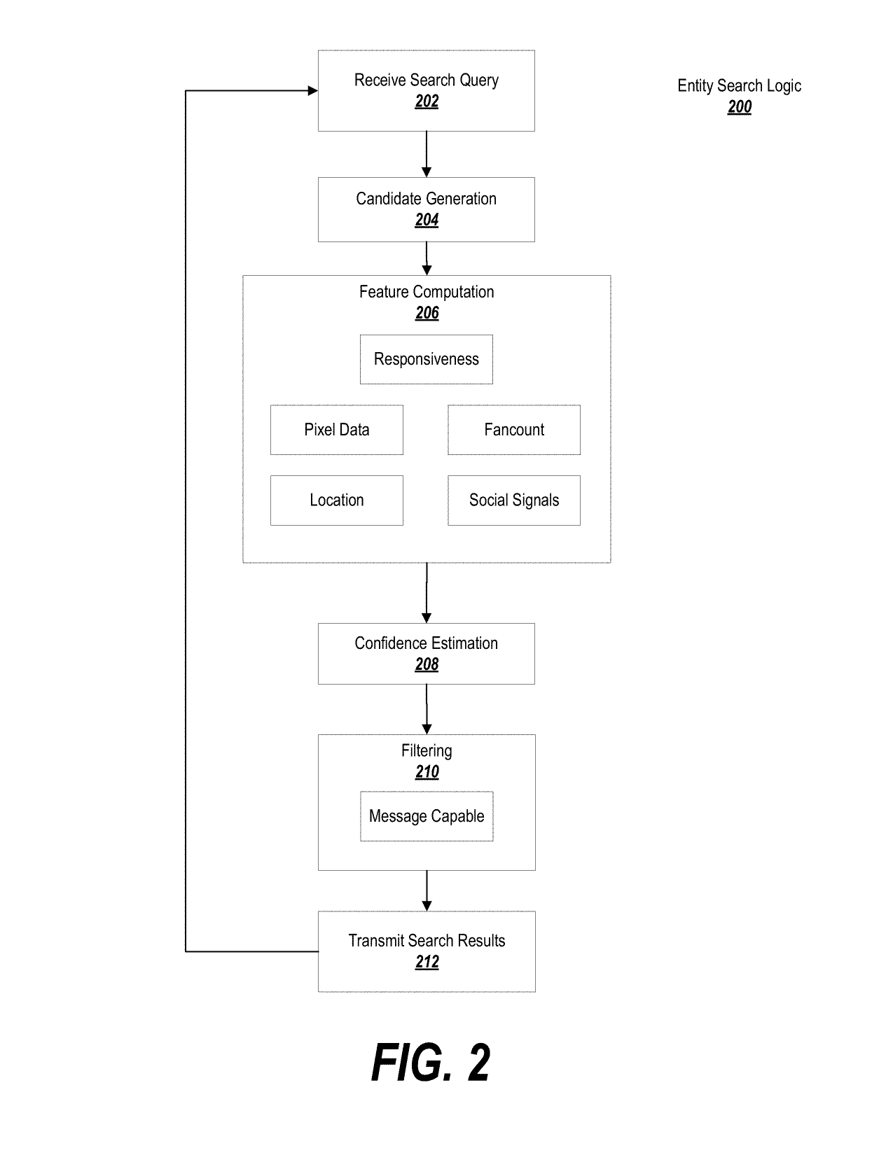

This brief summary is intended to serve as a non-limiting introduction to the concepts discussed in more detail below, in connection with FIGS. 2-5C. However, before discussing further exemplary embodiments, a brief note on data privacy is first provided. A more detailed description of privacy settings and authentication will be addressed in connection with the following Figures.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous and/or asynchronous video conversation in a messaging system is next provided

### Entity Search Based on Responsiveness

Any or all of the above-described interfaces may be presented as part of a set of procedures for performing an entity search in a social networking service. FIG. 2 is a flowchart depicting an exemplary process 200 for performing such a search.

The process 200 may be performed, for example, by a messaging server or social networking server interacting with a user of a messaging or social networking service through a network. Alternatively, some or all of the process 200 may be performed client-side on the searching user's client device. Although the operations described below refer to actions performed by a server, it is understood that these actions may also or alternatively be performed by a client device.

At block 202, a search query (such as a partial search query) may be received. The search query may be received on a network interface of the server. The search query may include, for example, a string of text or an audio recording that attempts to identify an entity. Furthermore, the search query may be in any graphical or character form. For example, the search query may include emoji, graphics such as stickers, etc. Such inputs may be associated with an identifier that identifies the graphic, and the search may be carried out on the basis of the identifier. In other embodiments, an image in the search may be processed with a graphical analysis component that may identify, for example, key features in the image that may be searched. The entity may be a user, messaging bot, business, organization, page, etc. in a social network.

In some embodiments, the search query received at block 202 may be a full search query. For example, a full search query may be received, but the full search query may fail to exactly match any entities available to the search engine (e.g., no entities having the searched name may be found in a social networking service that is the subject of the search). In this case, the search may be carried out in an attempt to identify the closest match available.

In further embodiments, the input received at block 202 may be a null input. For example, when a user first clicks on a search bar (prior to entering any characters or graphics in the search field), a null search may be conducted. The null search may be based on recent activity performed by the searching user, affinities associated with the searching user, or other information associated with the searching user. A default list of results may also be returned.

As used herein, a search query may include a partial search query, a complete search query, or a null search query

At block 204, the server may perform a candidate generation process. In the candidate generation process, the server generates entity candidates for each sub-span of a search query (i.e., for each n-gram of the query). For example, the search query “new york city bus” may have several sub-spans, including “new york,” “new york city,” “york,” and “city bus.”

After identifying sub-spans, the server generates one or more entity candidates for each sub-span. To do this, the server may consult multiple different sources, such as online encylopedias, celebrity page names, and bootstrap entities (i.e., entities connected to the querying user) from information stored on the social network's social graph. For example, the server may query an encyclopedia such as Wikipedia to generate several entity candidates from the text “london.” Such candidates may include the city in the UK, the town in Ontario, Canada, London Records (a company in the UK), or Jack London (the famous author). Each of these entity candidates may be assigned a unique identifier (and thus represented by a unique node in the social graph). In some embodiments, the consulted sources may be crawled and/or indexed while a client device is online to generate information. The generated information may be locally stored or cached so that it remains available while the device is offline. Accordingly, entity candidates may be generated without the need to consult a server or third-party device during the candidate generation process.

Within the consulted sources, one or more anchors such as hyperlinks may be present. For example, the Beatles Wikipedia page may say that the Beatles performed in London, with an anchor (hyperlink) of the text “London” to the Wikipedia page for the city of London in the UK. By counting anchors for each entity candidate, the server may calculate the probability that a particular entity links to a particular search query. For example, 95% of all “london” anchors may link to the city in the UK, 3% may link to London, Ontario, Canada, 1% to London Records, and 1% to Jack London. These percentages may then be used as a signal to determine how likely it is that a particular entity candidate links with a given search query.

Alternatively or in addition, the server may generate entity candidates via a bootstrap process. To accomplish this, the server may build a reverse index from bootstrap entities (e.g., entities stored in a particular user's social graph), retrieve all the entities that match a segment of the query or other text string, and keep only the longest match. For example, “Kennedy” may refer to John F. Kennedy, the Kennedy Center in Washington D.C., and another user, named Kennedy Martinez. A user Alex may search “Kennedy” and the SN may access the bootstrap entities associated with Alex's social-graph information. For instance, Alex may be friends with Kennedy Martinez on the social network, and may have recently visited the Kennedy Center to see a musical. He may also have liked a page associated with John F. Kennedy, or read an article about the former president. Each of these actions may correspond to different affinity scores between Alex and the different entities. Reading an article about JFK may produce a lower affinity score than checking in at the Kennedy Center, which may in turn produce a lower affinity score than interacting with Kennedy Martinez on the online social network many times over several months.

Although the examples given above attempt to match the search query to a name of the entity, it is noted that the candidate entities need not necessarily be matched to the names of the entities. For example, entities may be associated with metadata such as a description, a location, a type or category of entity or service, etc. The metadata may be searched, alone or in conjunction with the entity name, in order to generate candidates for further review.

Based on the affinity scores and other contextual clues (e.g., location, current events, anchors), the server may determine which Kennedy most likely links with Alex's search query (i.e., the Kennedy that Alex intended to reference with the search query). Bootstrap entities may be stored client-side in order to quickly match search queries with relevant search results.

An entity forward index may contain information that is stored in memory for each entity (e.g., each entity may be associated with a social networking page and an identifier). The forward index may store information such as the number of Wikipedia in-links, the number of likes associated with the entity, the entity name, etc. A canonical identifier may be used for disambiguation for different entities that have the same name (e.g., “London” can refer to several different entities).

The result of the candidate generation block 204 may be a list of candidate entities. In some cases, the partial search query may match only one entity in the social network, in which case that entity is returned as the only search result in block 212. However, in the event that he search query potentially matches two or more results, processing proceeds to block 206.

At block 206, a feature computation process may be performed. In the feature computation process, the server takes the entity candidates that it generated in the candidate generation block 204 and generates features for the entity candidates.

The features can be used to model the probability that an entity candidate is the intended entity referenced by a given text string. Some features model the overall popularity of an entity candidate (e.g., by using the number of likes a social networking page has, the number of Wikipedia in-links, etc.).

Other features model the overall probability of an entity candidate given the text in which the search query is mentioned. To evaluate such features, the server may analyze the text in various sources where the entity is mentioned (e.g., in a Wikipedia article, or in a post by another user of the social network in the case of bootstrap).

The features may also include context features, which may be used to measure the compatibility of the text outside of the mention with the mention itself. For example, “the statue of liberty” is more closely associated with the entity New York City than with the entity New York Giants. To make this measurement and determination, the server may topic2vec word embeddings, which contain embeddings for words and entities together. It may use the word2vec paradigm, which uses surrounding words in an n-dimensional vector space to predict a particular word. In addition to training based on word-core currencies, it may also use a rule-based topic tagger. It may extract entity identifiers and compute embeddings for the identifiers in addition to the words. Given an entity identifier and words, the server may compute a similarity between the two. This feature helps the server rank entity candidates based on the context.

The server may also distinguish between keywords and entity words. Essentially any word that is not a namestring for an entity can be a keyword, though some n-grams that match namestrings may be intended as keyword queries. The server may predict the probability that a word is an entity or a keyword given the text in the string. This can be expressed by the formula p(type|text). This formula expresses the probability that a given n-gram is either an entity or a keyword (i.e., the type of the n-gram) given particular text associated with the n-gram (e.g., adjacent n-grams). The server may distinguish between different entity types as well (e.g., the type could include a person, a messaging bot, a company name, a location, etc.).

According to exemplary embodiments, one feature considered when evaluating entity candidates is the responsiveness of the entity candidate. The social networking service may track messaging metrics, such as how long it takes, on average, for a given entity to respond to a message. Another tracked metric may be the frequency at which messages are responded to (e.g., the number of messages responded to over a given time period), as well as the ratio of responded messages to unresponded-to messages. The responsiveness may be based on responses to messages received by the entity through the social networking service, a messaging service associated with the social networking service, or both. The responsiveness may be used to increase or decrease the rank of the entity candidate in the confidence estimation step 208, discussed below.

The feature computation block 206 may also consider information relating to tracking pixels. Entities in the social networking service may be associated with webpages, and may place one or more tracking pixels their webpages. When a user accesses one of these web pages, the user's device is redirected to a tracking server, thereby providing contextual information to the server (e.g., last URL visited, user's id, device info, etc.). The advertiser may provide the tracking server with a set of rules that operate on the pixel data to perform various functions, such as adding the user to a targeting audience, performing attribution of a conversion, reporting analytics, etc. This tracking data may be used to determine if the user has had previous contact with an entity, and to what degree the user has interacted with the entity.

Other metrics considered in the feature computation block 206 include the entity's fancount (e.g., the number of users that follow or “like” the entity in the social networking service), the entity's location (e.g., entities located closer to a user may be ranked higher than entities located further from a user), and social signals associated with the entity. The social signals may include information pertaining to the entity as registered in the searching user's social graph. For example, social signals may include whether the searching user's friends have liked the entity, commented on the entity's posts, or messaged the entity.

At block 208, the server may perform a confidence estimation process. Each feature may be associated with a weight. Once the server has generated entity candidates and assigned features to those candidates, it uses the weights for the features to assign a probability to each of the generated candidates. For example, the text “new york city bus” may be a search string. This string may be divided into several segments: “new york,” “new york city,” “city bus,” are some examples. Each segment may correspond to multiple entities stored in the social networking service (each entity represented by a unique identifier). The server may assign probabilities to these entity candidates, wherein the probabilities represent the likelihood that the entity candidate is the appropriate entity (e.g., the entity that the user intended to reference in the search query).

To continue the “new york city bus” example, the segment “new york city” may correspond to two entities stored on the social network with ID numbers 177 and 901, respectively. ID No. 177 may represent the city of New York, N.Y. ID No. 901 may represent the USS New York City, the only ship of the United States Navy to be named after the city of New York, N.Y. The probability assigned to ID No. 177 may be 0.75, and the probability assigned to ID No. 901 may be 0.03 (the different probabilities being due to the features discussed above). The probability assigned to ID No. 177 is much higher than the probability assigned to ID No. 901 because, for example, the city of New York has more Wikipedia inbound-links, has more interaction on the social network, and likely has a closer connection on the social graph to the user who entered the string “new york city bus.”

To assign a score of each of the entity candidates, the server may use a technique called segmental conditional random field (CRF). Generally, CRF assigns probabilities to variables taking into account both the variable in question and surrounding variables. For example, in speech recognition, CRF considers both the wave form of a particular frame of speech, and the words preceding and following that particular frame. Segmental CRF goes one step further, by not only taking into account surrounding variables, but also considering other observations and features that may help decode a signal. In the context of speech recognition, these other observations may include phoneme detections, template match scores, and topic detections. The observations are then used in assigning a probability to the variable in question.

To compute the score for an entity candidate, the server may implement the following formula:

seₖ=Σᵢwᵢ^{e}·fᵢ^{e}(eₖ,text)+Σⱼgⱼ^{t}·fⱼ^{t}(type(eₖ),text). Equation 1

The above formula represents the probability that a particular entity candidate or keyword candidate is the intended reference of a particular segment (e.g., the entity or keyword that the user intended to reference when entering the search query). The first half of the formula represents the features of the entity candidates (e.g., number of Wikipedia in-links, social graph data), and the second half represents the features of the types (e.g., entity or keyword). The first half of the formula takes the entity ID as the input, and the second half of the formula takes the type as the input. The probability for a complete assignment of entities (and keywords) to the input text may be represented as a log-linear model:

$$p ( y ) = \frac{{e}^{\sum {e}_{i} ∈ {y}^{s ( {e}_{i} )}}}{z} , \qquad Equation 2$$

where z is the normalizing constant, or the sum over all possible assignments. The numerator portion is a typical log-linear model. It takes each entity in a given path, computes the score, sums the score, and exponentiates it. It returns the score for an entire given path. To normalize the score for all paths, the server divides by the normalizing constant z. The normalizing constant z sums all assignments (where y′ is any particular assignment) as:

$$z = {\sum }_{{y}^{′}} {e}^{\sum {e}_{i} ∈ {y}^{s ( {e}_{i} )}} \qquad Equation 3$$

Thus, each feature's weight is used perform the confidence estimation. According to exemplary embodiments, responsiveness may be weighted more than or equal to pixel data, whereas pixel data may be weighted more than fancount, location, and social signals.

In some embodiments, other metrics may be first considered in order to determine which entities the search query most likely pertains to, and then factors such as responsiveness, pixel data, fancount, location, and social signals may be used to rearrange the top results (e.g., the highest n results, where n is a predetermined integer, or any results that are not filtered in block 210 below). In these embodiments, responsiveness may carry a greater or equal weight compared to pixel data

Some entity candidates may be associated with multiple nodes in a social graph. For example, if the user searches for a coffee shop named “Ishmael's Coffee,” there may be a number of Ishmael's franchises near the user. When determining how to rank the different franchise entities against each other, the more responsive of the franchise entities may be elevated over the less responsive of the franchise entities.

At block 210, the server may perform a filtering process. Filtering involves removing the entity candidates assigned low probabilities. This may be accomplished by either removing all entity candidates assigned probabilities below a particular threshold number, or alternatively, by removing a particular portion of low probability entity candidates (e.g., the bottom 50% of entity candidates). Continuing the “new york city bus” example, if the city of New York, N.Y. has a probability of 0.75 that it is the entity the user intended to reference in the search query, and the USS New York City only has a probability of 0.03, the server may remove USS New York City as an entity candidate, since it is highly likely that the USS New York City is not the intended entity candidate for the search query “new york city bus.”

Optionally, any entities that are not capable of sending or receiving messages through the messaging service may be filtered out at block 210. For example, if an entity in a social networking service is not set up to operate with an associated messaging service, or if the entity has messaging turned off, or is otherwise unable to send or receive messages, the entity may be filtered out at block 210. Alternatively or in addition, the rank or probability associated with the entity may be decreased to reduce the chance that the user messages the entity.

At block 212, the server may transmit the filtered search results back to the user's client device as a response to the search query. Based on the processing performed at block 208, the server may arrange the categories or types of entities. For example, the server may take the average confidence for each entity in a particular type, and arrange the types (e.g., the different sections under the headers 106 of FIG. 1A) based on the average confidence. Alternatively, the types may be arranged based on the most-confident result from each category (e.g., the confidence of the most-likely person as compared to the confidence of the most-likely business).

Processing then returns to block 202, and the server awaits a new partial search query (e.g., where the user enters additional text into a search field). Optionally, the server may store the results of each block 204, 206, 208, 210 in order to expedite processing if a further, more complete, search query is received.

The above-described logic 200 may be implemented as a rule-based system, or may be implemented with machine learning.

### Entity Discovery and Media Delivery

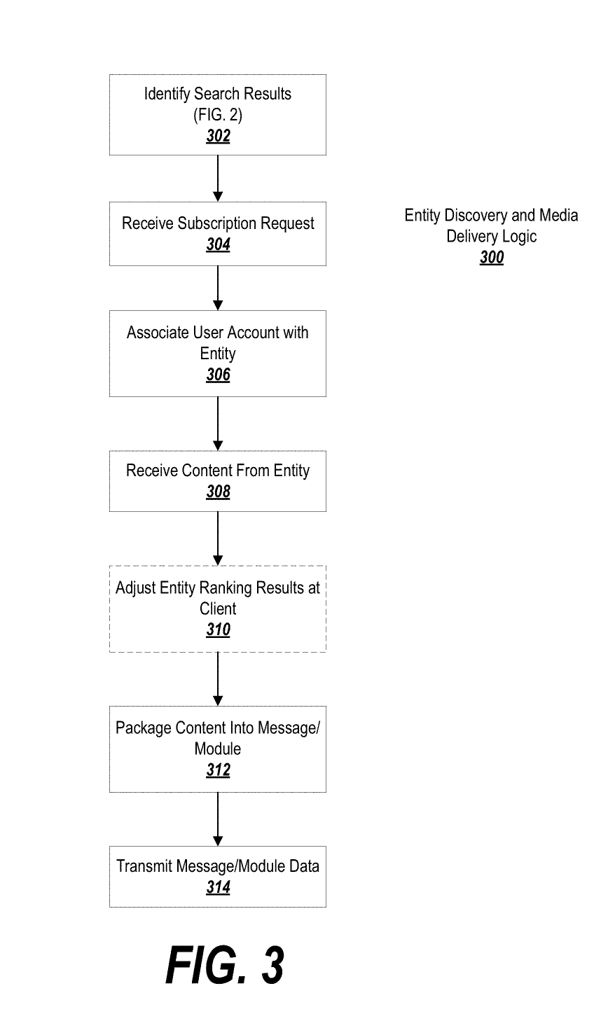

In conjunction with the entity search process of FIG. 2, the server may also facilitate subscription services involving the search results. For example, FIG. 3 is a flowchart depicting an exemplary process 300 for performing entity discovery and subscription media delivery. The actions described in connection with FIG. 3 may be performed by the server, the client device, or any combination thereof. For ease of discussion, it is assumed that the server performs all processing steps in the example below.

At block 302, the server may identify search results in response to a search query. This may be accomplished, for example, using the techniques described above in connection with FIG. 2, or with any other suitable searching techniques.

Some or all of the search results may be associated with a subscription option, and the server may transmit an identification of those entities that are subscribable in conjunction with the search results. The subscription may be a paid subscription. For example, the subscription may require subscribed-to entity to pay a fee for each message transmitted to a user, or may require a user to pay a fee for each message received from the entity. In another embodiment, the subscription may be associated with a flat or recurring fee for unlimited content, payable by the subscriber or the entity.

At block 304, the server may receive a subscription request. For example, the server may receive a request to subscribe to an entity by exercising the subscription option included in the search results. The subscription request may identify the subscribing user and the subscribed-to entity.

Alternatively or in addition, the subscription request may originate in a social networking service. For example, when a user interacts with an entity page in a social networking service (e.g., liking the page, commenting on the page, etc.), the user may optionally be subscribed to receive content and/or updates from the page.

At block 306, the server may associate the user account identified in the subscription request with the entity identified in the subscription request. This may involve maintaining a list or database of subscribers to a particular entity; the user account may be added to the list or database corresponding to the entity. This may allow the server to coordinate the transmission of messages received from the entity without the need for the entity to specifically address each message. Alternatively or in addition, the server may forward the subscription request directly to the entity, so that the entity may track subscribers and formulate its own messages.

At block 308, the server may receive content from the entity for distribution. For example, the entity may transmit a message directed to any subscribers of the entity. The message may include a media item, such as an article, picture, video, advertisement, etc. Alternatively or in addition, the entity may transmit the media item alone, outside the context of a message.

Optionally, at block 310 the server may review the media item and/or the entity, and adjust entity ranking results at the client. For example, based on the popularity of the media item and/or the entity on the social network, the display of the subscription content may be made more or less prominent on the user's display. In the event that a modular inbox such as the one depicted in FIG. 1C is used, the inter-module ranking of a module containing the subscription content may be raised or lowered based on this popularity. Alternatively or in addition, a message generated based on this content may be made more prominent and/or maintained on a main page of the messaging interface for a longer period of time.

At block 312, the server may package the received content into a message or, in the case of a modular inbox, an inbox module. In the case of a message, the message may be addressed from the subscribed entity to any subscribers in the list or table maintained by the server (or the entity may designate the recipients itself). In the case of a module, the server may add the content to an existing module dedicated to the entity, a different module dedicated to the same type of content but not dedicated to the entity (e.g., a generic videos or advertisements module), or a different module having different type of content (e.g., placing a coupon from the entity into a module dedicated to articles). At block 314, the server may transmit the message or module to the client of the subscribing user.

### Data Flow

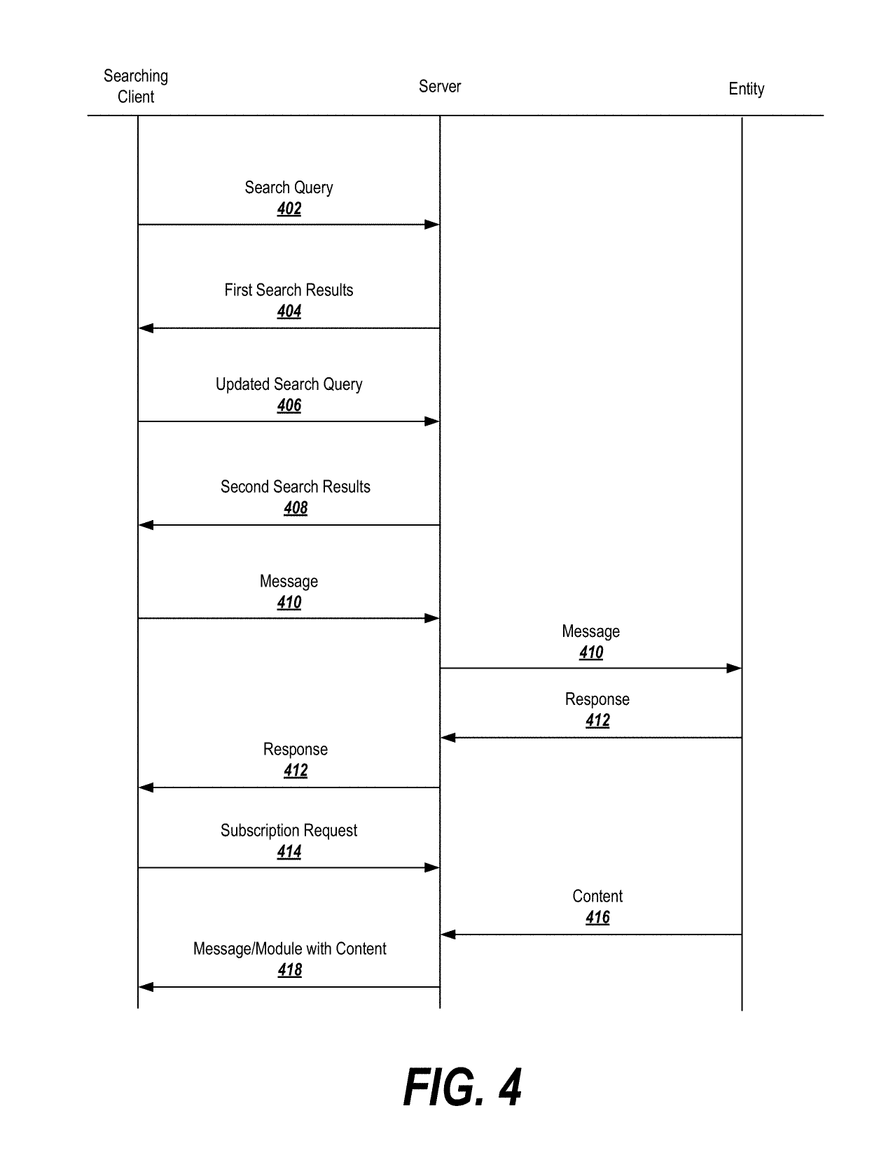

FIG. 4 is a data flow graph depicting exemplary exchanges of data between the above-mentioned server device, a searching client, and an entity in a social networking/messaging service.

The searching client may transmit a search query 402, such as a part of a string or entity name. The server may receive the search query 402 and process the search query as described above in connection with FIG. 2. As a consequence, the server may generate first search results 404, which may be transmitted to the searching client in a ranked order or along with a ranking of each result.

As the user continues to type into the search field, the searching client may generate further search queries and may transmit an updated search query 406. The server may process the updated search query 406 in the same manner as the original partial search query 402 and may return second search results 408.

Once the user has identified the entity they wish to message, the user may create a message 410, which is sent by the searching client to the server and relayed from the server to the entity. In reply to the message, the entity may generate a response 412, which the server may forward to the searching client.

Optionally, the user may choose to subscribe to the entity. In order to accomplish this, the searching client may generate a subscription request 414 and transmit the subscription request to the server. The server may maintain a subscriber list, or optionally may pass the subscription request 414 to the entity so that the entity may maintain its own subscriber list.

When the entity generates subscription content 416, the entity may forward the content 416 to the server. The server may consult the subscription list and may generate a message or module 418 including the content. The server may transmit the message or module 418 to the searching client.

### Messaging System Overview

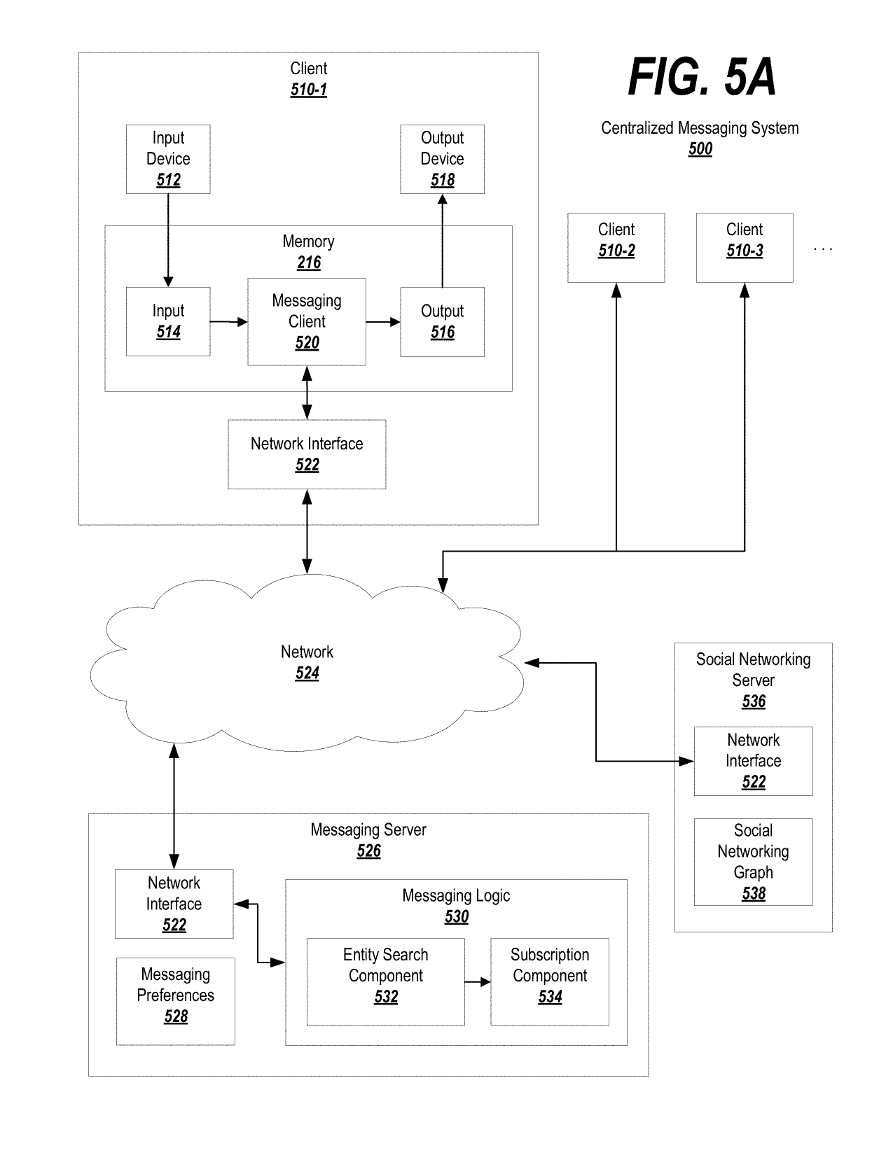

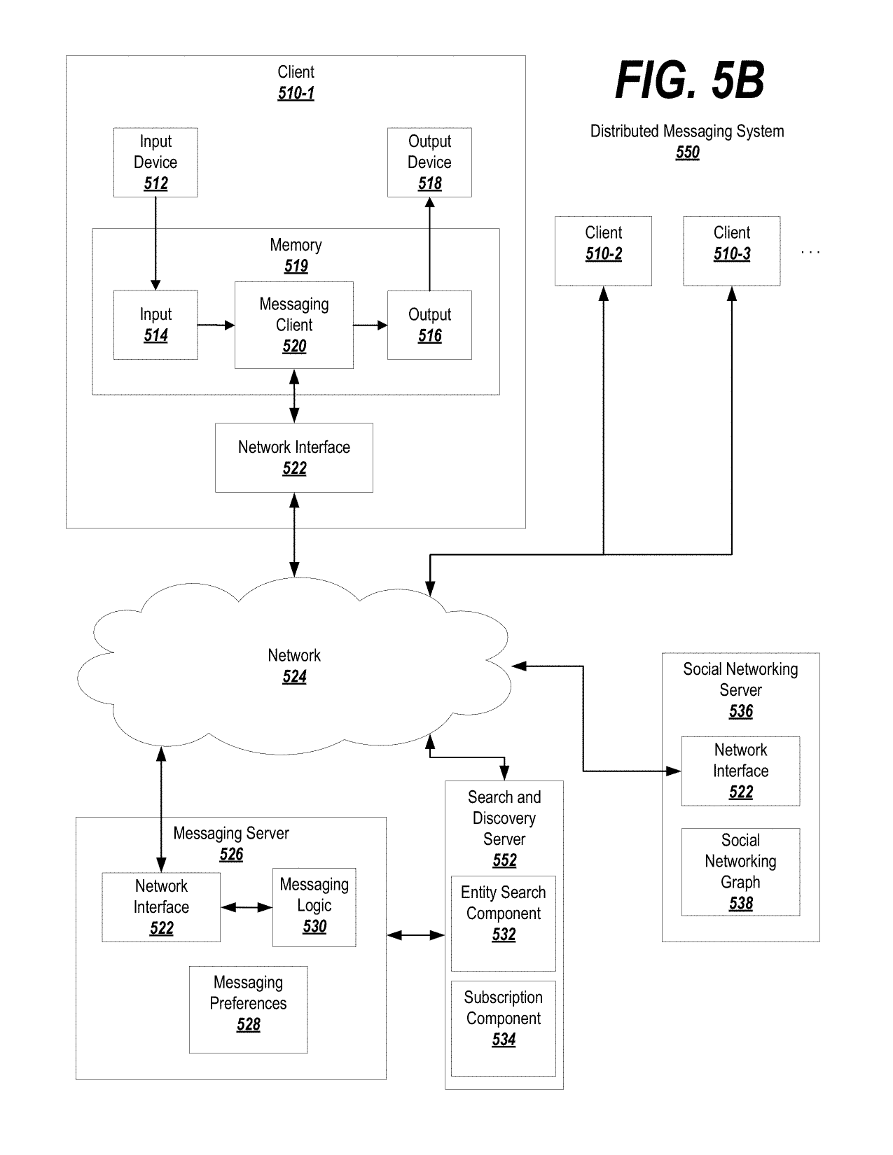

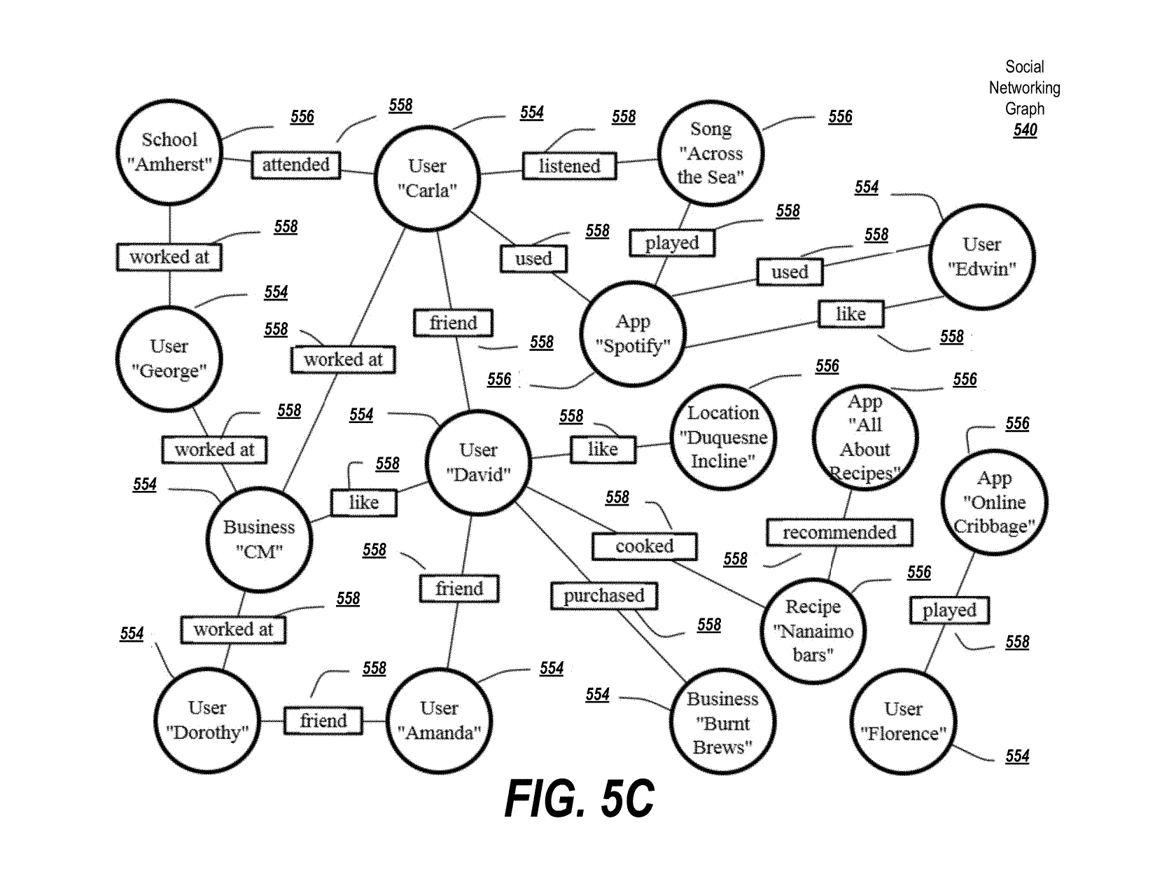

These examples may be implemented by a messaging system that is provided either locally, at a client device, or remotely (e.g., at a remote server). FIGS. 5A-5C depict various examples of messaging systems, and are discussed in more detail below.

FIG. 5A depicts an exemplary centralized messaging system 500, in which functionality for recognizing productive intent and generating a list of suggested recipients is integrated into a messaging server. The centralized system 500 may implement some or all of the structure and/or operations of a messaging service in a single computing entity, such as entirely within a single centralized server device 526.

The messaging system 500 may include a computer-implemented system having software applications that include one or more components. Although the messaging system 500 shown in FIG. 5A has a limited number of elements in a certain topology, the messaging system 500 may include more or fewer elements in alternate topologies.

A messaging service 500 may be generally arranged to receive, store, and deliver messages. The messaging service 500 may store messages while messaging clients 520, such as may execute on client devices 510, are offline and deliver the messages once the messaging clients are available.

A client device 510 may transmit messages addressed to a recipient user, user account, or other identifier resolving to a receiving client device 510. In exemplary embodiments, each of the client devices 510 and their respective messaging clients 520 are associated with a particular user or users of the messaging service 500. In some embodiments, the client devices 510 may be cellular devices such as smartphones and may be identified to the messaging service 500 based on a phone number associated with each of the client devices 510. In some embodiments, each messaging client may be associated with a user account registered with the messaging service 500. In general, each messaging client may be addressed through various techniques for the reception of messages. While in some embodiments the client devices 510 may be cellular devices, in other embodiments one or more of the client devices 510 may be personal computers, tablet devices, any other form of computing device.

The client 510 may include one or more input devices 512 and one or more output devices 518. The input devices 512 may include, for example, microphones, keyboards, cameras, electronic pens, touch screens, and other devices for receiving inputs including message data, requests, commands, user interface interactions, selections, and other types of input. The output devices 518 may include a speaker, a display device such as a monitor or touch screen, and other devices for presenting an interface to the messaging system 500.

The client 510 may include a memory 519, which may be a non-transitory computer readable storage medium, such as one or a combination of a hard drive, solid state drive, flash storage, read only memory, or random access memory. The memory 519 may a representation of an input 514 and/or a representation of an output 516, as well as one or more applications. For example, the memory 519 may store a messaging client 520 and/or a social networking client that allows a user to interact with a social networking service.

The input 514 may be textual, such as in the case where the input device 212 is a keyboard. Alternatively, the input 514 may be an audio recording, such as in the case where the input device 512 is a microphone. Accordingly, the input 514 may be subjected to automatic speech recognition (ASR) logic in order to transform the audio recording to text that is processable by the messaging system 500. The ASR logic may be located at the client device 510 (so that the audio recording is processed locally by the client 510 and corresponding text is transmitted to the messaging server 526), or may be located remotely at the messaging server 526 (in which case, the audio recording may be transmitted to the messaging server 526 and the messaging server 526 may process the audio into text). Other combinations are also possible—for example, if the input device 512 is a touch pad or electronic pen, the input 514 may be in the form of handwriting, which may be subjected to handwriting or optical character recognition analysis logic in order to transform the input 512 into processable text.

The client 510 may be provided with a network interface 522 for communicating with a network 524, such as the Internet. The network interface 522 may transmit the input 512 in a format and/or using a protocol compatible with the network 524 and may receive a corresponding output 516 from the network 524.

The network interface 522 may communicate through the network 524 to a messaging server 526. The messaging server 526 may be operative to receive, store, and forward messages between messaging clients.

The messaging server 526 may include a network interface 522, messaging preferences 528, and messaging logic 530. The messaging preferences 528 may include one or more privacy settings for one or more users and/or message threads. For example, the messaging preferences 528 may include a setting that indicates whether to create new conversations using a canonical or non-canonical implementation when pivoting from a one-on-one to a group conversation. Furthermore, the messaging preferences 528 may include one or more settings, including default settings, for the logic described herein.

The messaging logic 530 may include an entity searching component 532 that is operable to evaluate search queries and return a ranked list of search results. The messaging logic 530 may further include a subscription component 534 that is operable to manage subscriptions between users and entities.

In some embodiments, messages may be sent peer-to-peer between users without the use of intervening server devices such as may implement the messaging service 500. In these embodiments, the messaging logic 530, including the entity search component 532 and the subscription component 534, may reside on the client devices 510.

The network interface 522 of the client 510 and/or the messaging server 526 may also be used to communicate through the network 524 with a social networking server 536. The social networking server 536 may include or may interact with a social networking graph 538 that defines connections in a social network. Furthermore, the messaging server 526 may connect to the social networking server 536 for various purposes, such as retrieving connection information, messaging history, event details, etc. from the social network.

A user of the client 510 may be an individual (human user), an entity (e.g., an enterprise, business, or third-party application), or a group (e.g., of individuals or entities) that interacts or communicates with or over the social networking server 536. The social-networking server 536 may be a network-addressable computing system hosting an online social network. The social networking server 536 may generate, store, receive, and send social-networking data, such as, for example, user-profile data, concept-profile data, social-graph information, or other suitable data related to the online social network. The social networking server 536 may be accessed by the other components of the network environment either directly or via the network 524.

The social networking server 536 may include an authorization server (or other suitable component(s)) that allows users to opt in to or opt out of having their actions logged by social-networking server 536 or shared with other systems (e.g., third-party systems, such as the messaging server 526), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking server 536 through blocking, data hashing, anonymization, or other suitable techniques as appropriate.

More specifically, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular elements of the social networking graph 538. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social networking server 536 or shared with other systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In response to a request from a user (or other entity) for a particular object stored in a data store, the social networking server 536 may send a request to the data store for the object. The request may identify the user associated with the request. The requested data object may only be sent to the user (or a client system 510 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results.

In some embodiments, targeting criteria may be used to identify users of the social network for various purposes. Targeting criteria used to identify and target users may include explicit, stated user interests on social-networking server 536 or explicit connections of a user to a node, object, entity, brand, or page on social networking server 536. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also implicate privacy settings (such as user opt-outs), data hashing, or data anonymization, as appropriate.

The centralized embodiment depicted in FIG. 5A may be well-suited to deployment as a new system or as an upgrade to an existing system, because the logic for pivoting to a group conversation (e.g., the logic of the intent determination component 532 and/or the logic of the group selection component 534) are incorporated into the messaging server 526. In contrast, FIG. 5B depicts an exemplary distributed messaging system 550, in which functionality for recognizing productive intent and generating a list of suggested recipients is distributed and remotely accessible from the messaging server. Examples of a distributed system 550 include a client-server architecture, a 3-tier architecture, an N-tier architecture, a tightly-coupled or clustered architecture, a peer-to-peer architecture, a master-slave architecture, a shared database architecture, and other types of distributed systems.

Many of the components depicted in FIG. 5B are identical to those in FIG. 5A, and a description of these elements is not repeated here for the sake of brevity. The primary difference between the centralized embodiment and the distributed embodiment is the addition of a separate search and discovery server 552, which hosts the entity search component 532 and the subscription component 534. The search and discovery server 552 may be distinct from the messaging server 526 but may communicate with the messaging server 526, either directly or through the network 524, to provide the functionality of the entity search component 532 and the subscription component 534 to the messaging server 526.

The embodiment depicted in FIG. 5B may be particularly well suited to allow exemplary embodiments to be deployed alongside existing messaging systems, for example when it is difficult or undesirable to replace an existing messaging server. Additionally, in some cases the messaging server 526 may have limited resources (e.g. processing or memory resources) that limit or preclude the addition of the additional pivot functionality. In such situations, the capabilities described herein may still be provided through the separate pivot server 552.

FIG. 5C illustrates an example of a social networking graph 538. In exemplary embodiments, a social networking service may store one or more social graphs 538 in one or more data stores as a social graph data structure via the social networking service.

The social graph 538 may include multiple nodes, such as user nodes 554 and concept nodes 556. The social graph 228 may furthermore include edges 558 connecting the nodes. The nodes and edges of social graph 228 may be stored as data objects, for example, in a data store (such as a social-graph database). Such a data store may include one or more searchable or queryable indexes of nodes or edges of social graph 228.

The social graph 538 may be accessed by a social-networking server 226, client system 210, third-party system (e.g., the translation server 224), or any other approved system or device for suitable applications.

A user node 554 may correspond to a user of the social-networking system. A user may be an individual (human user), an entity (e.g., an enterprise, business, or third-party application), or a group (e.g., of individuals or entities) that interacts or communicates with or over the social-networking system. In exemplary embodiments, when a user registers for an account with the social-networking system, the social-networking system may create a user node 554 corresponding to the user, and store the user node 30 in one or more data stores. Users and user nodes 554 described herein may, where appropriate, refer to registered users and user nodes 554 associated with registered users. In addition or as an alternative, users and user nodes 554 described herein may, where appropriate, refer to users that have not registered with the social-networking system. In particular embodiments, a user node 554 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 554 may be associated with one or more data objects corresponding to information associated with a user. In particular embodiments, a user node 554 may correspond to one or more webpages. A user node 554 may be associated with a unique user identifier for the user in the social-networking system.

In particular embodiments, a concept node 556 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 556 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 556 may be associated with one or more data objects corresponding to information associated with concept node 556. In particular embodiments, a concept node 556 may correspond to one or more webpages.

In particular embodiments, a node in social graph 538 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 556. Profile pages may be viewable by all or a selected subset of other users. As an example and not by way of limitation, a user node 554 may have a corresponding user-profile page in which the corresponding user may add content, make declarations, or otherwise express himself or herself. A business page such as business page 205 may comprise a user-profile page for a commerce entity. As another example and not by way of limitation, a concept node 556 may have a corresponding concept-profile page in which one or more users may add content, make declarations, or express themselves, particularly in relation to the concept corresponding to concept node 556.

In particular embodiments, a concept node 556 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 554 corresponding to the user and a concept node 556 corresponding to the third-party webpage or resource and store edge 558 in one or more data stores.

In particular embodiments, a pair of nodes in social graph 538 may be connected to each other by one or more edges 558. An edge 558 connecting a pair of nodes may represent a relationship between the pair of nodes. In particular embodiments, an edge 558 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 558 connecting the first user's user node 554 to the second user's user node 554 in social graph 538 and store edge 558 as social-graph information in one or more data stores. In the example of FIG. 5C, social graph 538 includes an edge 558 indicating a friend relation between user nodes 554 of user “Amanda” and user “Dorothy.” Although this disclosure describes or illustrates particular edges 558 with particular attributes connecting particular user nodes 554, this disclosure contemplates any suitable edges 558 with any suitable attributes connecting user nodes 554. As an example and not by way of limitation, an edge 558 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 538 by one or more edges 558.

In particular embodiments, an edge 558 between a user node 554 and a concept node 556 may represent a particular action or activity performed by a user associated with user node 554 toward a concept associated with a concept node 556. As an example and not by way of limitation, as illustrated in FIG. 5C, a user may “like,” “attended,” “played,” “listened,” “cooked,” “worked at,” or “watched” a concept, each of which may correspond to a edge type or subtype. A concept-profile page corresponding to a concept node 556 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 558 and a “used” edge (as illustrated in FIG. 5C) between user nodes 554 corresponding to the user and concept nodes 556 corresponding to the song and application to indicate that the user listened to the song and used the application. Moreover, the social-networking system may create a “played” edge 558 (as illustrated in FIG. 5C) between concept nodes 556 corresponding to the song and the application to indicate that the particular song was played by the particular application. In this case, “played” edge 558 corresponds to an action performed by an external application (SPOTIFY) on an external audio file (the song “Across the Sea”). Although this disclosure describes particular edges 558 with particular attributes connecting user nodes 554 and concept nodes 556, this disclosure contemplates any suitable edges 558 with any suitable attributes connecting user nodes 554 and concept nodes 556. Moreover, although this disclosure describes edges between a user node 554 and a concept node 556 representing a single relationship, this disclosure contemplates edges between a user node 554 and a concept node 556 representing one or more relationships. As an example and not by way of limitation, an edge 558 may represent both that a user likes and has used at a particular concept. Alternatively, another edge 558 may represent each type of relationship (or multiples of a single relationship) between a user node 554 and a concept node 556 (as illustrated in FIG. 5C between user node 554 for user “Edwin” and concept node 556 for “SPOTIFY”).

In particular embodiments, the social-networking system may create an edge 558 between a user node 554 and a concept node 556 in social graph 538. As an example and not by way of limitation, a user viewing a concept-profile page (such as, for example, by using a web browser or a special-purpose application hosted by the user's client system) may indicate that he or she likes the concept represented by the concept node 556 by clicking or selecting a “Like” icon, which may cause the user's client system to send to the social-networking system a message indicating the user's liking of the concept associated with the concept-profile page. In response to the message, the social-networking system may create an edge 558 between user node 554 associated with the user and concept node 556, as illustrated by “like” edge 558 between the user and concept node 556. In particular embodiments, the social-networking system may store an edge 558 in one or more data stores. In particular embodiments, an edge 558 may be automatically formed by the social-networking system in response to a particular user action. As an example and not by way of limitation, if a first user uploads a picture, watches a movie, or listens to a song, an edge 558 may be formed between user node 554 corresponding to the first user and concept nodes 556 corresponding to those concepts. Although this disclosure describes forming particular edges 558 in particular manners, this disclosure contemplates forming any suitable edges 558 in any suitable manner.

The social graph 538 may further comprise a plurality of product nodes. Product nodes may represent particular products that may be associated with a particular business. A business may provide a product catalog to a consumer-to-business service and the consumer-to-business service may therefore represent each of the products within the product in the social graph 538 with each product being in a distinct product node. A product node may comprise information relating to the product, such as pricing information, descriptive information, manufacturer information, availability information, and other relevant information. For example, each of the items on a menu for a restaurant may be represented within the social graph 538 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 538. The information for a product node may be manipulated by the social-networking system as a product object that encapsulates information regarding the referenced product.

As such, the social graph 538 may be used to infer shared interests, shared experiences, or other shared or common attributes of two or more users of a social-networking system. For instance, two or more users each having an edge to a common business, product, media item, institution, or other entity represented in the social graph 538 may indicate a shared relationship with that entity, which may be used to suggest customization of a use of a social-networking system, including a messaging system, for one or more users.

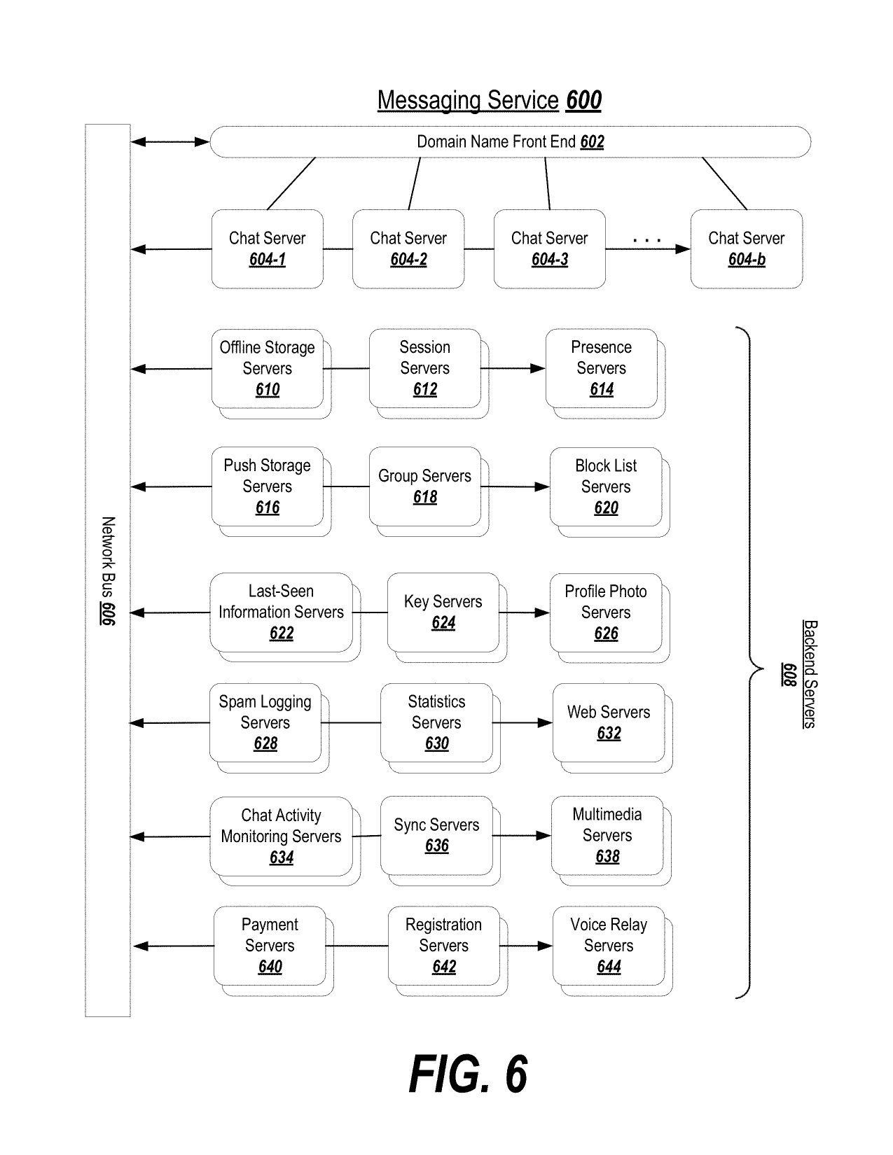

The embodiments described above may be performed by a messaging architecture, an example of which is next described with reference to FIG. 6.

### Messaging Architecture

FIG. 6 illustrates an embodiment of a plurality of servers implementing various functions of a messaging service 600. It will be appreciated that different distributions of work and functions may be used in various embodiments of a messaging service 600.

The messaging service 600 may comprise a domain name front end 602. The domain name front end 602 may be assigned one or more domain names associated with the messaging service 600 in a domain name system (DNS). The domain name front end 602 may receive incoming connections and distribute the connections to servers providing various messaging services.

The messaging service 602 may comprise one or more chat servers 604. The chat servers 604 may comprise front-end servers for receiving and transmitting user-to-user messaging updates such as chat messages. Incoming connections may be assigned to the chat servers 604 by the domain name front end 602 based on workload balancing.

The messaging service 600 may comprise backend servers 608. The backend servers 608 may perform specialized tasks in the support of the chat operations of the front-end chat servers 604. A plurality of different types of backend servers 608 may be used. It will be appreciated that the assignment of types of tasks to different backend serves 608 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging service 600 may comprise one or more offline storage servers 610. The one or more offline storage servers 610 may store messaging content for currently-offline messaging clients in hold for when the messaging clients reconnect.

The messaging service 600 may comprise one or more sessions servers 612. The one or more session servers 612 may maintain session state of connected messaging clients.

The messaging service 600 may comprise one or more presence servers 614. The one or more presence servers 614 may maintain presence information for the messaging service 600. Presence information may correspond to user-specific information indicating whether or not a given user has an online messaging client and is available for chatting, has an online messaging client but is currently away from it, does not have an online messaging client, and any other presence state.

The messaging service 600 may comprise one or more push storage servers 616. The one or more push storage servers 616 may cache push requests and transmit the push requests to messaging clients. Push requests may be used to wake messaging clients, to notify messaging clients that a messaging update is available, and to otherwise perform server-side-driven interactions with messaging clients.

The messaging service 600 may comprise one or more group servers 618. The one or more group servers 618 may maintain lists of groups, add users to groups, remove users from groups, and perform the reception, caching, and forwarding of group chat messages.

The messaging service 600 may comprise one or more block list servers 620. The one or more block list servers 620 may maintain user-specific block lists, the user-specific incoming-block lists indicating for each user the one or more other users that are forbidden from transmitting messages to that user. Alternatively or additionally, the one or more block list servers 620 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 600 may comprise one or more last seen information servers 622. The one or more last seen information servers 622 may receive, store, and maintain information indicating the last seen location, status, messaging client, and other elements of a user's last seen connection to the messaging service 600.

The messaging service 600 may comprise one or more key servers 624. The one or more key servers may host public keys for public/private key encrypted communication.

The messaging service 600 may comprise one or more profile photo servers 626. The one or more profile photo servers 626 may store and make available for retrieval profile photos for the plurality of users of the messaging service 600.

The messaging service 600 may comprise one or more spam logging servers 628. The one or more spam logging servers 628 may log known and suspected spam (e.g., unwanted messages, particularly those of a promotional nature). The one or more spam logging servers 628 may be operative to analyze messages to determine whether they are spam and to perform punitive measures, in some embodiments, against suspected spammers (users that send spam messages).

The messaging service 600 may comprise one or more statistics servers 630. The one or more statistics servers may compile and store statistics information related to the operation of the messaging service 600 and the behavior of the users of the messaging service 600.

The messaging service 600 may comprise one or more web servers 632. The one or more web servers 632 may engage in hypertext transport protocol (HTTP) and hypertext transport protocol secure (HTTPS) connections with web browsers.

The messaging service 600 may comprise one or more chat activity monitoring servers 634. The one or more chat activity monitoring servers 634 may monitor the chats of users to determine unauthorized or discouraged behavior by the users of the messaging service 600. The one or more chat activity monitoring servers 634 may work in cooperation with the spam logging servers 628 and block list servers 620, with the one or more chat activity monitoring servers 634 identifying spam or other discouraged behavior and providing spam information to the spam logging servers 628 and blocking information, where appropriate to the block list servers 620.

The messaging service 600 may comprise one or more sync servers 636. The one or more sync servers 636 may sync the messaging system 500 with contact information from a messaging client, such as an address book on a mobile phone, to determine contacts for a user in the messaging service 600.

The messaging service 600 may comprise one or more multimedia servers 638. The one or more multimedia servers may store multimedia (e.g., images, video, audio) in transit between messaging clients, multimedia cached for offline endpoints, and may perform transcoding of multimedia.

The messaging service 600 may comprise one or more payment servers 640. The one or more payment servers 640 may process payments from users. The one or more payment servers 640 may connect to external third-party servers for the performance of payments.

The messaging service 600 may comprise one or more registration servers 642. The one or more registration servers 642 may register new users of the messaging service 600.

The messaging service 600 may comprise one or more voice relay servers 644. The one or more voice relay servers 644 may relay voice-over-internet-protocol (VoIP) voice communication between messaging clients for the performance of VoIP calls.

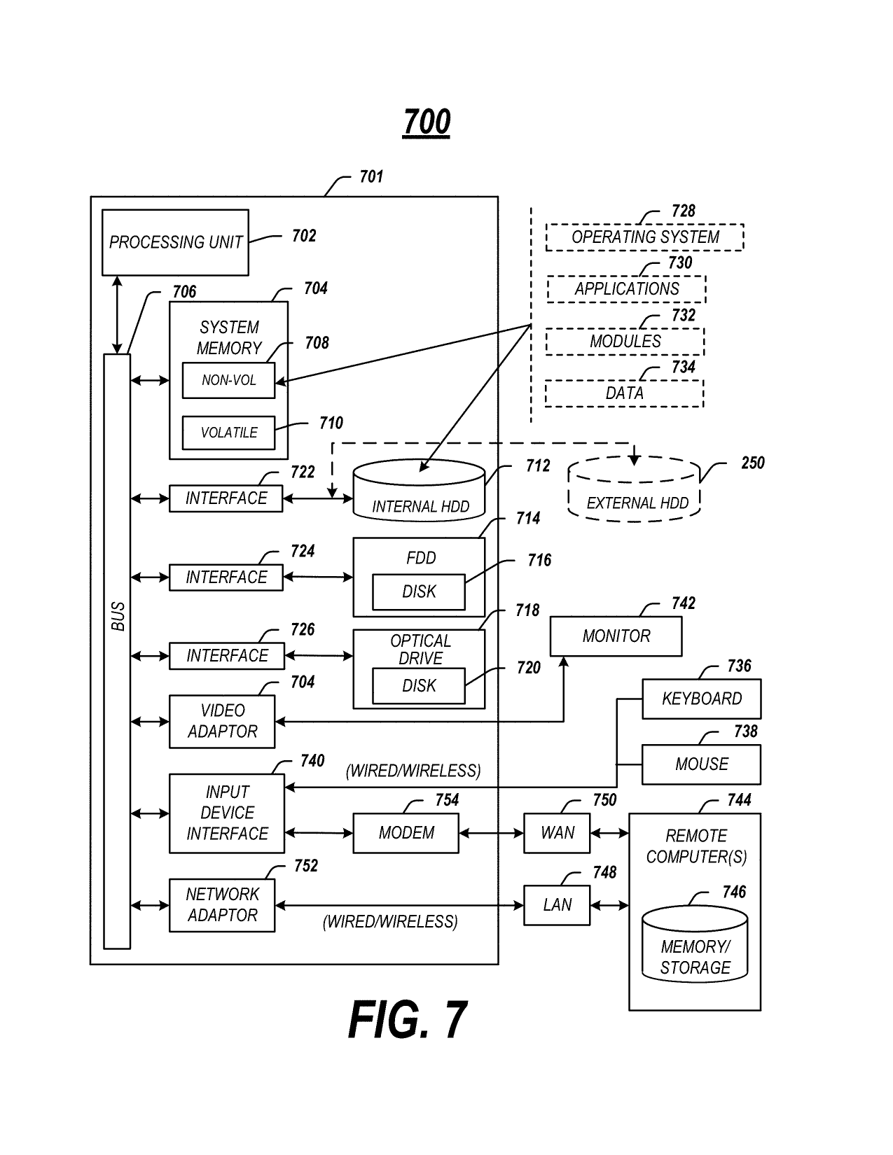

The above-described methods may be embodied as instructions on a computer readable medium or as part of a computing architecture. FIG. 7 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a system bus 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 702.

The system bus 706 provides an interface for system components including, but not limited to, the system memory 704 to the processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the messaging system 500.

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor 744. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

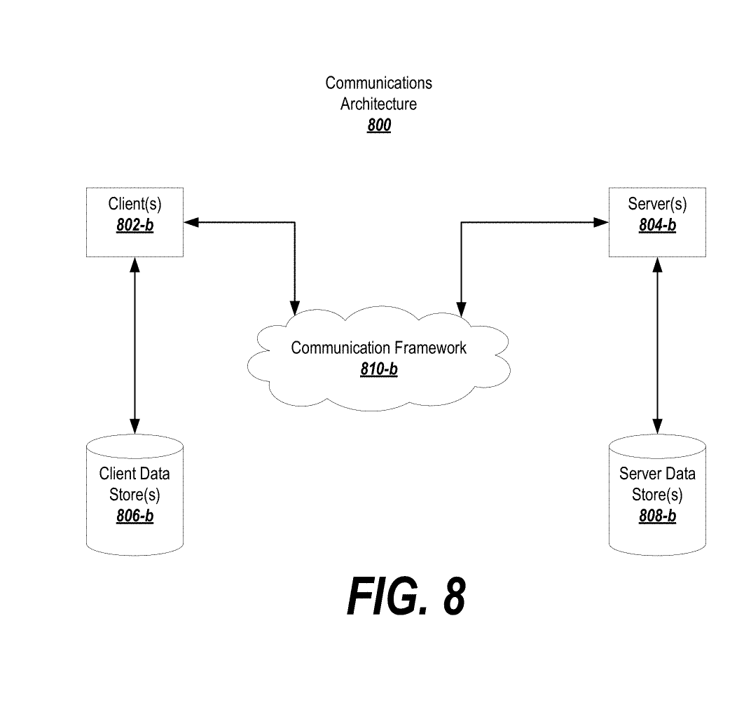

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 may implement the client device 510. The servers 804 may implement the server device 526. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

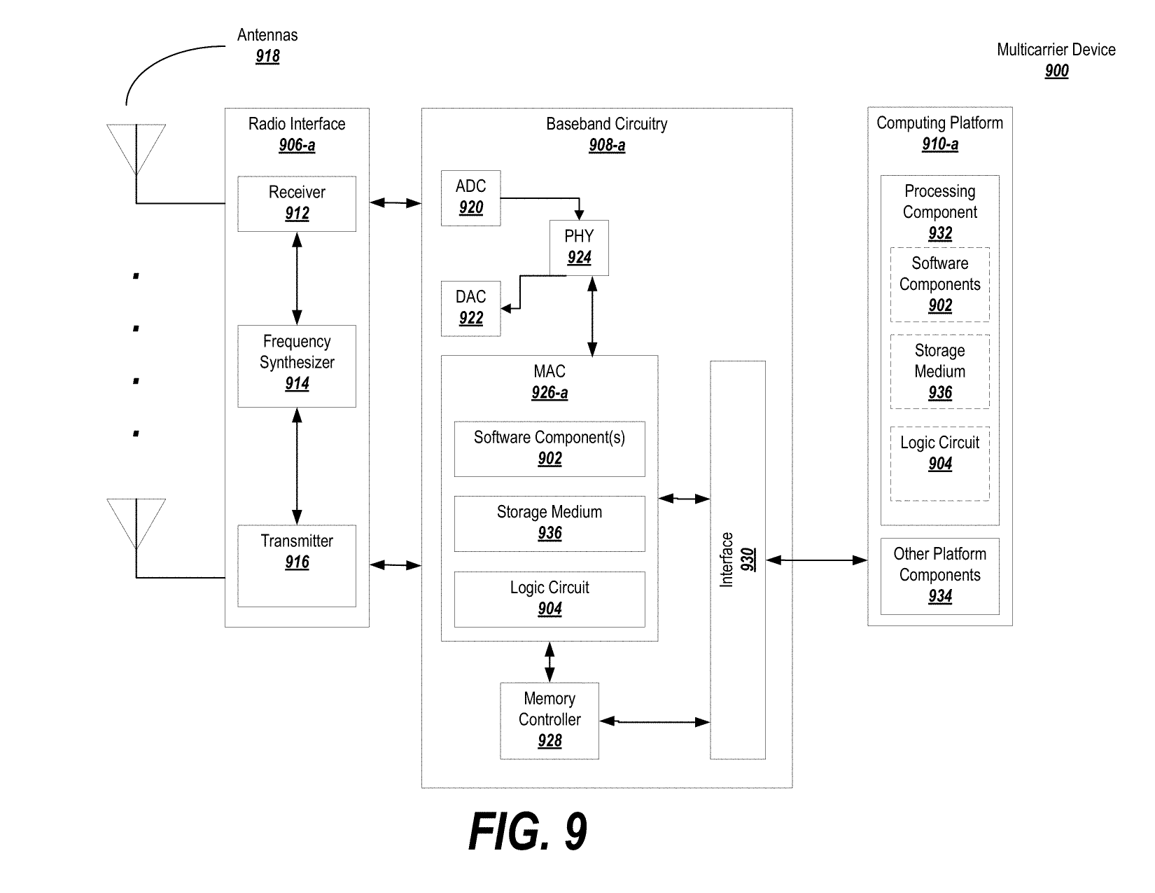

FIG. 9 illustrates an embodiment of a device 900 for use in a multicarrier OFDM system, such as the messaging system 500. The device 900 may implement, for example, software components 902 as described with reference to the messaging component logic 600, the intent determination logic 700, and the group selection logic 800. The device 900 may also implement a logic circuit 904. The logic circuit 904 may include physical circuits to perform operations described for the messaging system 600. As shown in FIG. 9, device 900 may include a radio interface 906, baseband circuitry 908, and a computing platform 910, although embodiments are not limited to this configuration.

The device 900 may implement some or all of the structure and/or operations for the messaging system 500 and/or logic circuit 904 in a single computing entity, such as entirely within a single device. Alternatively, the device 900 may distribute portions of the structure and/or operations for the messaging system 600 and/or logic circuit 904 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, the radio interface 906 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio interface 906 may include, for example, a receiver 912, a transmitter 914 and/or a frequency synthesizer 916. The radio interface 906 may include bias controls, a crystal oscillator and/or one or more antennas 918. In another embodiment, the radio interface 906 may use external voltage-controlled oscillators (VCOs), surface acoustic wave filters, intermediate frequency (IF) filters and/or RF filters, as desired. Due to the variety of potential RF interface designs an expansive description thereof is omitted.

The baseband circuitry 908 may communicate with the radio interface 906 to process receive and/or transmit signals and may include, for example, an analog-to-digital converter 920 for down converting received signals, and a digital-to-analog converter 922 for up-converting signals for transmission. Further, the baseband circuitry 908 may include a baseband or physical layer (PHY) processing circuit 924 for PHY link layer processing of respective receive/transmit signals. The baseband circuitry 908 may include, for example, a processing circuit 926 for medium access control (MAC)/data link layer processing. The baseband circuitry 908 may include a memory controller 928 for communicating with the processing circuit 926 and/or a computing platform 910, for example, via one or more interfaces 930.

In some embodiments, the PHY processing circuit 924 may include a frame construction and/or detection module, in combination with additional circuitry such as a buffer memory, to construct and/or deconstruct communication frames, such as radio frames. Alternatively or in addition, the MAC processing circuit 926 may share processing for certain of these functions or perform these processes independent of the PHY processing circuit 924. In some embodiments, MAC and PHY processing may be integrated into a single circuit.

The computing platform 910 may provide computing functionality for the device 900. As shown, the computing platform 910 may include a processing component 932. In addition to, or alternatively of, the baseband circuitry 908, the device 900 may execute processing operations or logic for the messaging system 500 and logic circuit 904 using the processing component 932. The processing component 932 (and/or the PHY 924 and/or MAC 926) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 910 may further include other platform components 934. Other platform components 934 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

The device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of the device 900 described herein, may be included or omitted in various embodiments of the device 900, as suitably desired. In some embodiments, the device 900 may be configured to be compatible with protocols and frequencies associated one or more of the 3GPP LTE Specifications and/or IEEE 1402.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of the device 900 may be implemented using any combination of discrete circuitry, application specific integrated circuits (ASICs), logic gates and/or single chip architectures. Further, the features of the device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium 936 may include instructions that, when executed, cause a system to perform any of the computer-implemented methods described herein.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method, comprising:
receiving a partial search query, the partial search query matching a first search result associated with a first entity in a social networking service and a second search result associated with a second entity in the social networking service;
determining that the first entity has a greater responsiveness than the second entity;
assigning a relevance to the first entity and the second entity, the relevance of the first entity being increased based on the greater responsiveness of the first entity;
transmitting search results, the first entity being prioritized over the second entity in the search results.

2. The method of claim 1, wherein the entities include at least one messaging bot or an organization.

3. The method of claim 1, wherein assigning the relevance further comprises increasing the relevance of the first entity or the second entity based on pixel data associated with the first entity or the second entity.

4. The method of claim 1, wherein assigning the relevance further accounts for one or more of a location of the first entity or the second entity in comparison to a user submitting the partial search query, a fancount of the first entity or the second entity, or social signal information associated with the user's account in the social network.

5. The method of claim 1, wherein the responsiveness is a measure of how quickly the entities respond to messages.

6. The method of claim 1, wherein the responsiveness is a measure of how frequently the entities respond to messages

7. The method of claim 1, wherein the partial search query also matches a third entity, the third entity not being capable of messaging, and transmitting the search results comprises refraining from including the third entity in the search results

8. A non-transitory computer-readable medium storing instructions configured to cause one or more processors to:
receive a partial search query, the partial search query matching a first search result associated with a first entity in a social networking service and a second search result associated with a second entity in the social networking service;
determine that the first entity has a greater responsiveness than the second entity;
assign a relevance to the first entity and the second entity, the relevance of the first entity being increased based on the greater responsiveness of the first entity;
transmit search results, the first entity being prioritized over the second entity in the search results.

9. The medium of claim 8, wherein the entities include at least one messaging bot or an organization.

10. The medium of claim 8, wherein assigning the relevance further comprises increasing the relevance of the first entity or the second entity based on pixel data associated with the first entity or the second entity.

11. The medium of claim 8, wherein assigning the relevance further accounts for one or more of a location of the first entity or the second entity in comparison to a user submitting the partial search query, a fancount of the first entity or the second entity, or social signal information associated with the user's account in the social network.

12. The medium of claim 8, wherein the responsiveness is a measure of how quickly the entities respond to messages.

13. The medium of claim 8, wherein the responsiveness is a measure of how frequently the entities respond to messages

14. The medium of claim 8, wherein the partial search query also matches a third entity, the third entity not being capable of messaging, and transmitting the search results comprises refraining from including the third entity in the search results

15. An apparatus comprising:
a non-transitory computer readable medium configured to store instructions for performing a search of a social networking service; and
a processor configured to execute the instructions, the instructions configured to cause the processor to:
receive a partial search query, the partial search query matching a first search result associated with a first entity in the social networking service and a second search result associated with a second entity in the social networking service;
determine that the first entity has a greater responsiveness than the second entity;
assign a relevance to the first entity and the second entity, the relevance of the first entity being increased based on the greater responsiveness of the first entity;
transmit search results, the first entity being prioritized over the second entity in the search results.

16. The apparatus of claim 15, wherein the entities include at least one messaging bot or an organization.

17. The apparatus of claim 15, wherein assigning the relevance further comprises increasing the relevance of the first entity or the second entity based on pixel data associated with the first entity or the second entity.

18. The apparatus of claim 15, wherein assigning the relevance further accounts for one or more of a location of the first entity or the second entity in comparison to a user submitting the partial search query, a fancount of the first entity or the second entity, or social signal information associated with the user's account in the social network.

19. The apparatus of claim 15, wherein the responsiveness is a measure of how quickly the entities respond to messages, or of how frequently the entities respond to messages

20. The apparatus of claim 15, wherein the partial search query also matches a third entity, the third entity not being capable of messaging, and transmitting the search results comprises refraining from including the third entity in the search results.
